(19) United States
(12) Patent Application Publication
(10) Pub. No.: US 2021/0392852 A1
(43) Pub. Date: Dec. 23, 2021

(54) Dog Recreation Device

(71) Applicant: Michael Gabel, University City, MO (US)

(72) Inventor: Michael Gabel, University City, MO (US)

(21) Appl. No.: 16/907,528

(22) Filed: Jun. 22, 2020

(51) Int. Cl. A01K 1/04

(52) U.S. Cl. CPC A01K 1/04

(57) ABSTRACT

A portable dog recreation device (10) for indoor and outdoor use by pet owners to leash their dog to the device so the dog can comfortably move about 360° tangled free within a defined area. The device has a base (12) so weighted that a dog tethered to it cannot move it about while a person can readily move it from one place to another using a handle (32). A post (20) is attached to and extends from the top of the base. The post may be integrally formed with the base or may be a separate piece. The outer diameter of the post is such that one end of a dog leash can be slipped over or tied about the post to tether the dog to the device. More than one dog can be tethered to the post at the same time.

### CROSS-REFERENCE TO RELATED APPLICATIONS

U.S. design patent application Ser. No. 29/736,138 filed May 28, 2020.

### STATEMENT REGARDING FEDERALLY SPONSORED RESEARCH OR DEVELOPMENT

Not Applicable.

### BACKGROUND OF THE INVENTION

Dogs are owned by numerous people most of whom keep their pets inside their home at least part, if not most, of the time. While dogs may be sedentary and tend to remain in one area of a home most of the time they are indoors, many, if allowed to, will wander about the premises where they are kept. While most of this wandering is benign, dogs do sometimes get into areas where they are not supposed to be and cause damage or create turmoil for their owner.

One way of preventing such occurrences is to cage the animal when it is indoors, or erect a barrier of some sort which, while allowing the dog some freedom of movement, confines it within a defined area. Most pet owners are uncomfortable with caging their pet for a prolonged period of time or confining their dog in a very restricted space. Caged dogs tend to whine or bark in trying to attract the attention of someone who might let them out of their cage, and confining the dog within a restricted area often does not work because the animal will find a way to escape from its confinement. Further, creating some type of confined space barrier raises issues as to how large a space can be accommodated within the confines of a home even if the dog will stay within the area and not escape from it.

Another way of controlling a dog's movements indoors is to place it on a leash having one end that is secured to a dog collar with the other end attached to, for example, a piece of furniture such as the leg of a chair, sofa, or table. Doing so allows the dog a certain freedom of movement with someone keeping an eye on it. However, this solution creates the possibility of the furniture being damaged by actions of the dog and/or the dog gets tangled with the furniture.

What is needed is a device that a dog owner can easily move about their home and set up in different convenient areas as appropriate. When leashed to the device, the dog will have enough room to move comfortably about; for example, more than 360° while remaining tangle free, and without being able to get into any trouble or cause problems for their owner.

### BRIEF SUMMARY OF THE INVENTION

The present invention is directed to a dog recreation device for indoor and outdoor use by pet owners. The device is a portable device the owner can readily move about within their premises to a desired location with the dog then being leashed to the device so as to be able to comfortably move about but without creating problems for its owner.

The device first has a base which is a hollow base that is filled with water, sand, or other material so its weight is such the device cannot be moved about by the movement of a dog, or dogs, tethered to it. The weight, however, is such that a person can readily move the device from one location to another, as desired.

The device next has a rigid, one-piece post, attached to and extending from the top of the base a desired distance. The post can be integrally formed with the base or may be a separate piece that is rigidly affixed to the top of the base. The post has a generally uniform outer diameter throughout its length, this diameter being such that one end of a leash, the other end of which is attached to a dog's collar or harness, can be slipped over or tied about the post to tether the dog to the device.

A handle is connected to the top of the post for grasping by a person wanting to move the device from one location to another.

The device and its components can be of a molded plastic or metal construction, or a combination of both. The size of the device is such that, when not in use, it is easily moved to an out-of-the-way storage location so to not clutter up the area where it is typically placed.

The device is relatively low cost and is available in a variety of colors.

Other objects and features will be in part apparent and in part pointed out hereinafter.

### BRIEF DESCRIPTION OF THE DRAWINGS

FIG. 1 is a perspective view of a dog recreation device of the present invention with a dog tethered to the device;

FIG. 2 is a top plan view of the device;

FIG. 3 is a bottom plan view of the device; and,

FIGS. 4-7 are respective side elevation views of the device.

Corresponding reference numerals will be used throughout the several figures of the drawings.

### DETAILED DESCRIPTION OF THE INVENTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what I presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

Referring to the drawings, a recreational device 10 is for use with a dog D. Device 10 allows the dog D, or dogs, tethered to the device to have a limited freedom of movement within a defined area A inside a premises so the dog can freely move about within the defined area 360° tangled free. See FIG. 1. This enables the dog D to get exercise while, at the same time, not allowing it to cause disruptions of the household or damage objects outside area A.

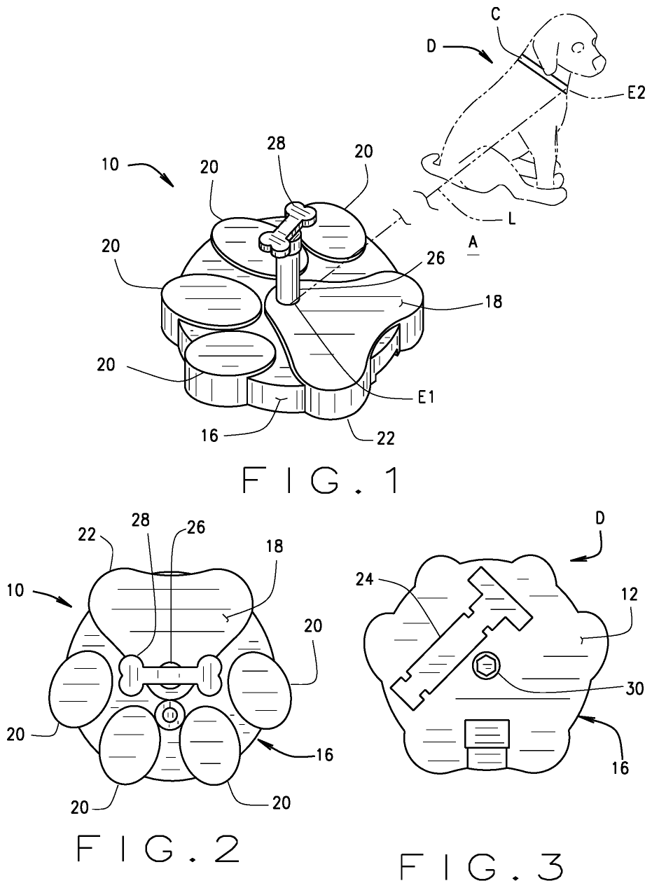

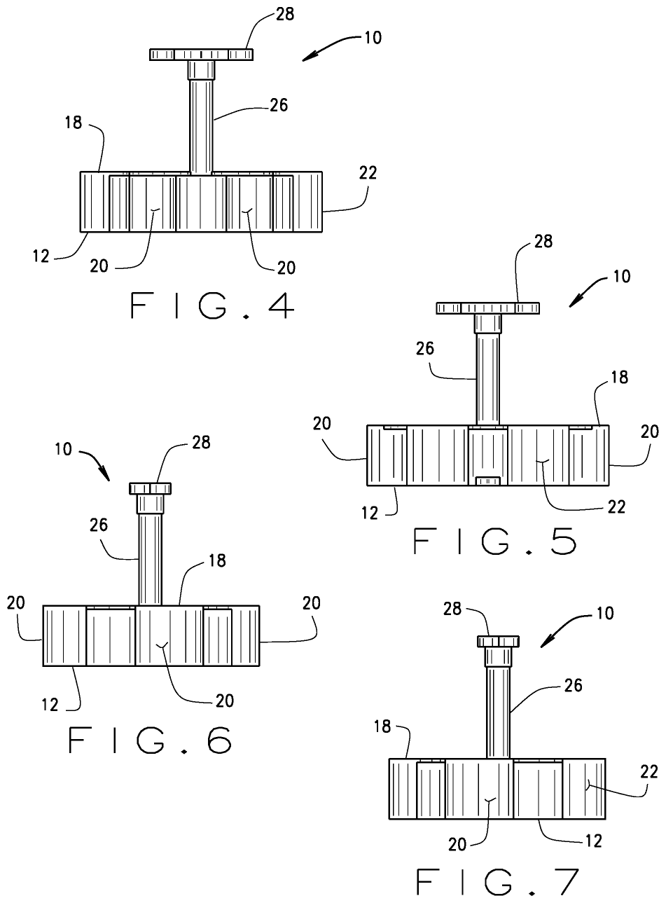

Device 10 first includes a base 12 having a flat bottom surface 14 that rests upon a floor or carpet, a sidewall 16, and a top surface 18. As best shown in the top plan view of FIG. 2, device 10 is generally shaped like a dog's paw having four separate spaced apart cylindrically shaped paw segments 20 representing the portions of a dog's paw pad from which a dog's toes protrude, and a separate spaced apart lobular shaped segment 22 representing a rear pad portion of a paw. The respective segments 20 and 22 are of the same height and all the segments are taller than the height of the base intermediate these segments.

Base 12 is of a molded plastic material and the interior of the base is hollow. As shown in FIG. 3, base 12 has a recess 24 formed in it which is sized and shaped to receive a post 26 and handle 28 of the device for storage when the device is not in use. The base further has an opening closed by a removable plug 30 plugged. This is to allow the hollow base to be filled with water or sand, or other material to add weight to the base. The weighting is such that device 10 is readily movable by a person from one location to another; but, at the same time, is not movable by a dog tethered to the device, despite any movements by the dog.

Post 26 is a one-piece, rigid post that extends vertically from top surface 18 of device 10 a predetermined height above the top surface. The outer diameter of post 26, which is uniform throughout the length of the post, is such that one end E1 of a dog leash L readily fits over or otherwise attaches to the post with the other end E2 of the leash being fastened to a dog's collar or harness C so to tether the dog to device 10.

Base 12 and post 26 of device 10 can, in one embodiment of the invention, be molded or cast together so to have a unitary one-piece construction. In other embodiments, post 26 is a separate piece the lower end of which is threaded or otherwise formed for connection or engagement with a corresponding central opening, not shown, in top surface 18 of device 10.

A handle 28 is affixed to the top of post 26 for grasping by the person wanting to move device 10 from one place to another. As shown in the drawings, handle 28 is shaped like a bone which is inserted in the top of handle 26 so to extend horizontally. This makes it easy for the person to grasp the handle and move the device. In one embodiment of the invention, bone shaped handle 28 is molded together with post 24 so to form a unitary one-piece construction. In another embodiment, post 26 has a generally rounded opening in its upper end with a middle portion of bone shaped handle 28 sized to snuggly fit within this opening to attach the handle to the post.

Those skilled in the art will understand that device 10 can be of a plastic or a metal construction. Also, while not shown in the drawings, the device can be of a variety of other sizes and shapes without departing from the scope of the invention. The device can be of one color, or the base, post, and handle can be of different colors. Also, the outside of the device can be finished in a decorative motif.

The separate parts of device 10 are readily assembled for use; and, once assembled, the device is easily moved about the inside or outside of a premises to any convenient location. When not being used, the device is readily movable to an out-of-the-way location.

In view of the above, it will be seen that the several objects and advantages of the present invention have been achieved and other advantageous results have been obtained.

As various changes could be made in the above constructions without departing from the scope of the invention, it is intended that all matter contained in the above description or shown in the accompanying drawings shall be interpreted as illustrative and not in a limiting sense.

1. A recreational device for a dog which allows the dog to be tethered to the device and have a limited freedom of movement so the dog can freely move about 360° tangled free within a defined area inside or outside a premises so to get exercise while, at the same time, not cause disruptions to a household or damage objects outside the defined area, the device comprising:
a base having a flat bottom surface that rests upon a floor or carpet within the defined area, a sidewall, and a top surface, the base being weighted such that the device is movable by a person from one location to another, but which cannot be moved by a dog tethered to the device despite any movements by the dog;
a one-piece rigid post extending vertically from the top surface of the base to a predetermined height above the top surface, the diameter of the post enabling one end of a dog leash to fit over or otherwise be attached the post with the other end of the leash being fastened to a dog's collar or harness so to tether the dog to the device; and,
a handle affixed to the top of the post for grasping by the person to move the device from one place to another;
whereby the device allows the dog an unobstructed interaction with people and other pets within the defined area.

2. The recreational device of claim 1 wherein the base is a hollow base that can be filled with a material that adds weight to the device such that while the device is movable by the person from one place to another, the device cannot be moved by a dog tethered to the device despite any movements by the dog.

3. The recreational device of claim 2 in which the base is of a molded plastic construction and is in the shape of a dog's paw when viewed from above.

4. The recreational device of claim 3 in which the base has a plurality of separately spaced apart cylindrically shaped paw segments representing portions of a dog's pad from which a dog's toes protrude, and a separate spaced apart lobular shaped segment representing a rear pad portion of a paw.

5. The recreational device of claim 4 in which there are four separately spaced apart cylindrically shaped paw segments.

6. The recreational device of claim 1 in which the base and post are molded together so to be of a unitary one-piece construction.

7. The recreational device of claim 5 wherein the post has a uniform outer diameter throughout its length.

8. The recreational device of claim 1 in which the handle is a bone shaped handle that extends horizontally of the device so to facilitate grasping by the person wanting to move the device.

9. The recreational device of claim 7 in which the post and handle are of a unitary one-piece construction and the base has a recess formed therein for storing the post and handle.

10. The recreational device of claim 8 in which the post and handle are separate pieces with an upper end of the post being formed to receive a middle portion the handle.

11. The recreational device of claim 1 in which the base, post, and handle are separate pieces that are fitted together to form a completed device.

12. A recreational device for a dog which allows the dog to be tethered to the device and have a limited freedom of movement so the dog can freely move about 360° tangled free within a defined area inside or outside a premises so to get exercise while, at the same time, not cause disruptions to a household or damage objects outside the defined area, the device comprising:
a hollow, dog's paw shaped base having a flat bottom surface that rests upon a floor or carpet within the defined area, the base being weighted such that the device is movable by a person from one location to another, but which cannot be moved by a dog tethered to the device despite any movements by the dog, the base having a plurality of separately spaced apart cylindrically shaped paw segments representing a portions of a dog's paw pad from which a dog's toes protrude, and a separate spaced apart lobular shaped segment representing a rear pad portion of a paw, the height of the cylindrically shaped paw segments being of the same height as the lobular shaped segment, and all the respective segments being taller than a height of the base intermediate these segments;
a one-piece rigid post extending vertically from the top surface of the base to a predetermined height above the top surface, the diameter of the post enabling one end of a dog leash to fit over or otherwise be attached the post with the other end of the leash being fastened to a dog's collar or harness so to tether the dog to the device; and,
a handle affixed to the top of the post for grasping by the person to move the device from one place to another;
whereby the device allows the dog an unobstructed interaction with people and other pets within the defined area.

13. The recreational device of claim 11 in which there are four separately spaced apart cylindrically shaped paw segments.

14. The recreational device of claim 11 in which the post has a uniform outer diameter throughout its length with a bottom portion of the post being threaded so to threadably received in a correspondingly threaded opening in a top of the base.

15. The recreational device of claim 11 in which the handle is a bone shaped handle that extends horizontally of the device so to facilitate grasping by the person wanting to move the device.

16. The recreational device of claim 14 in which the post and handle are of a unitary one-piece construction and the base has a recess formed therein for storing the post and handle.

17. The recreational device of claim 15 in which the post and handle are separate pieces with an upper end of the post being formed to receive a middle portion the handle.

18. The recreational device of claim 11 in which the base, post, and handle are separate pieces that are fitted together to form a completed device.
